(19) United States
(12) Patent Application Publication
(10) Pub. No.: US 2007/0146587 A1
(43) Pub. Date: Jun. 28, 2007

(54) Liquid crystal display with positional marks

(75) Inventor: Ming-Hung Tsai, MiaoLi (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/645,413

(22) Filed: Dec. 26, 2006

(30) Foreign Application Priority Data
Dec. 23, 2005 (TW) 94146352

(51) Int. Cl. G02F 1/1333

(52) U.S. Cl. 349/110

(57) ABSTRACT

An exemplary liquid crystal display (LCD) has a first substrate (22), which has a first positional mark (224) having a first horizontal positional sub-mark (225) and a first vertical positional sub-mark (227), perpendicular to each other; a second substrate (24), which has a second positional mark (243) having a second horizontal positional sub-mark (245) and a second vertical positional sub-mark (247), perpendicular to each other. The first and the second horizontal positional marks correspond to each other, which each have a plurality of periodically distributed parallel lines; the first and the second vertical positional marks correspond to each other, which each have a plurality of vertical distributed parallel lines. When the first and the second substrate are assembled, the lines of the first and the second horizontal or vertical positional marks cross each other to form morie fringes.

### FIELD OF THE INVENTION

The present invention relates to liquid crystal displays (LCDs), and particularly to a liquid crystal display having a liquid crystal panel with positional marks.

### GENERAL BACKGROUND

With the ongoing development of semiconductor technology, an integrated circuit (IC) has been applied to various kinds of electronic equipment, including a liquid crystal display (LCD). There are three main conventional technologies for bonding an IC onto a liquid crystal panel of an LCD: chip on glass (COG), tape carrier package (TCP), and chip on film (COF).

Referring to FIG. 11, a typical liquid crystal panel has a first substrate 12 (shown in FIG. 11) and a second substrate 14 (shown in FIG. 12). The first substrate 12 has a plurality of gate lines 121 and a plurality of data lines 123 and four cross-shaped frames 127, the plurality of gate lines 121 and the plurality of data lines 123 crossing with each other to define a plurality of pixel region 124. The first substrate 12 further has a plurality of thin film transistor (TFT) at the intersections of the plurality of gate lines 121 and the plurality of data lines 123. The four cross-shaped frames 127 are positional marks, which are disposed at four corners of the first substrate 12.

The second substrate 14 has a color filter portions (not shown), a black matrix 141 and four cross-shaped patterns 143. When the first and the second substrates 12, 14 are assembled together, the black matrix 141 corresponds to the plurality of gate lines 121 and the plurality of data lines 123 of the first substrate 12 for preventing light beams from leaking thereof. The four cross-shaped patterns 143 each correspond to one cross-shaped frame 127.

With increased numbers of the plurality of gate lines 121 and the plurality of data lines 123, a pitch between any two adjacent gate line 121 and data lines 12 can be reduced. However, when the first substrate 12 is assembled with the second substrate 14, there is a risk of positioning deviation as between cross-shaped patterns 143 and the cross-shaped frames 127 because the cross-shaped patterns 143 can deviate in the cross-shaped frames 127 in a deviation range which can not be found by the operator. If positioning deviation occurs, this may cause low aperture ratio.

Therefore, a new liquid crystal display that can overcome the above-described problems is desired.

### SUMMARY

In one preferred embodiment, a liquid crystal display (LCD) has a first substrate, which has a first positional mark having a first horizontal positional sub-mark and a first vertical positional sub-mark, perpendicular to each other; a second substrate, which has a second positional mark having a second horizontal positional sub-mark and a second vertical positional sub-mark, perpendicular to each other. The first and the second horizontal positional marks correspond to each other, which each have a plurality of periodically distributed parallel lines; the first and the second vertical positional marks correspond to each other, which each have a plurality of vertical distributed parallel lines. When the first and the second substrate are assembled, the lines of the first and the second horizontal positional marks cross each other to form morie fringes, and the lines of first and the second vertical positional marks cross each other to form morie fringes too.

Other advantages and novel features will become more apparent from the following detailed description when taken in conjunction with the accompanying drawings.

### BRIEF DESCRIPTION OF THE DRAWINGS

FIG. 1 is a schematic, top plan view of a first substrate of a liquid crystal panel according to a first embodiment of the present invention.

FIG. 2 is a schematic, top plan view of a second substrate of a liquid crystal panel according to a second embodiment of the present invention.

FIG. 3 is a schematic view showing assembling the first substrate and the second substrate.

FIG. 4 is a schematic view showing a aligning pattern of two horizontal positional marks of the first substrate and the second substrate.

FIG. 5 is a schematic view showing a aligning pattern of two vertical positional marks of the first substrate and the second substrate.

FIG. 6 is a partly enlarged view showing an aligning pattern of the liquid crystal panel of FIG. 1 and FIG. 2.

FIG. 7 is a partly enlarged view of the positional mark.

FIG. 8 is a schematic, top plan view of the first substrate of FIG. 1, but further showing two chips and flexible printed board.

FIG. 9 is a schematic, plan view showing an alternative positional mark.

FIG. 10 is a schematic, plan view showing an another alternative positional mark.

FIG. 11 is a schematic, top plan view of a first substrate of a typical liquid crystal panel.

FIG. 12 is a schematic, top plan view of a second substrate of the typical liquid crystal panel of FIG. 11.

### DETAILED DESCRIPTION OF PREFERRED EMBODIMENTS

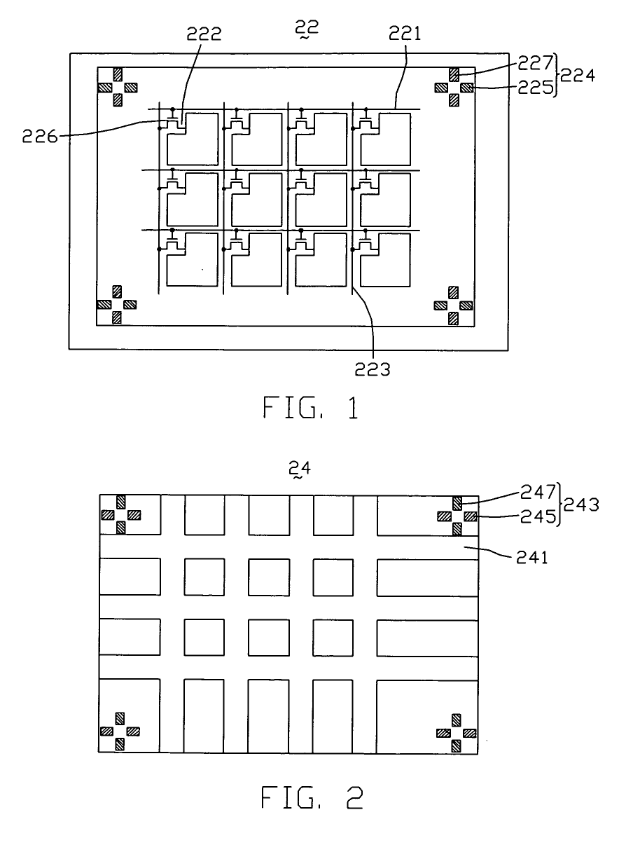

Referring to FIG. 1 and FIG. 2, a liquid crystal panel has a first substrate 22 (shown in FIG. 1) and a second substrate 24 (shown in FIG. 2). The first substrate 22 has a plurality of gate lines 221 and a plurality of data lines 223 and four positional marks 224. The plurality of gate lines 221 and the plurality of data lines 223 crosses with each other to define a plurality of pixel region 222. The first substrate 22 further has a plurality of thin film transistor (TFT) 226 at the intersections of the plurality of gate lines 221 and the plurality of data lines 223. The four first positional marks 224 are respectively disposed at four corners of the first substrate 22.

Each first positional mark 224 has two first horizontal sub-marks 225 and two first vertical sub-marks 227, which the two first horizontal sub-marks 225 are arranged along a horizontal line and the two first vertical sub-marks 227 are arranged along a vertical line. The horizontal line and the vertical line cross with each other to define a cross-shaped positional mark. Each first horizontal sub-marks 225 and each first vertical sub-marks 227 has a plurality of parallel lines distributed in a predetermined periods, which the lines are opaque. The distribution period of the first horizontal sub-marks 225 is same to that of the first vertical sub-marks 227. In addition, other regions, no lines covered, of each first horizontal sub-marks 225 and each first vertical sub-marks 227 is transparent.

The second substrate 24 has a color filter portions (not shown), a black matrix 241 and four second positional marks 243. When the first and the second substrates 22, 24 are assembled together, the black matrix 241 corresponds to the plurality of gate lines 221 and the plurality of data lines 223 of the first substrate 22 for preventing light beams from leaking thereof. The four positional marks 243 are respectively disposed at four corners of the second substrate 24, which are corresponding to those of the second positional marks 224 of the first substrate 24.

Each positional mark 243 has two second horizontal sub-marks 245 and two second vertical sub-marks 247, which the two second horizontal sub-marks 245 are arranged along a horizontal line, corresponding to the first horizontal sub-marks 225, and the two second vertical sub-marks 247 are arranged along a vertical line, corresponding to the first vertical sub-marks 227. The horizontal line and the vertical line cross with each other to define a cross-shaped positional mark. Each second horizontal sub-marks 245 and each second vertical sub-marks 247 have a plurality of parallel lines distributed in a predetermined periods, which the lines are opaque. The distribution period of the second horizontal sub-marks 245 is same to that of the second vertical sub-marks 247. The lines of second horizontal sub-marks 245 has a different extending direction from that of the first horizontal sub-marks 225, and the lines of second vertical sub-marks 247 has a different extending direction from that of the first vertical sub-marks 227. In addition, other regions, no lines covered, of each second horizontal sub-marks 245 and each second vertical sub-marks 247 is transparent.

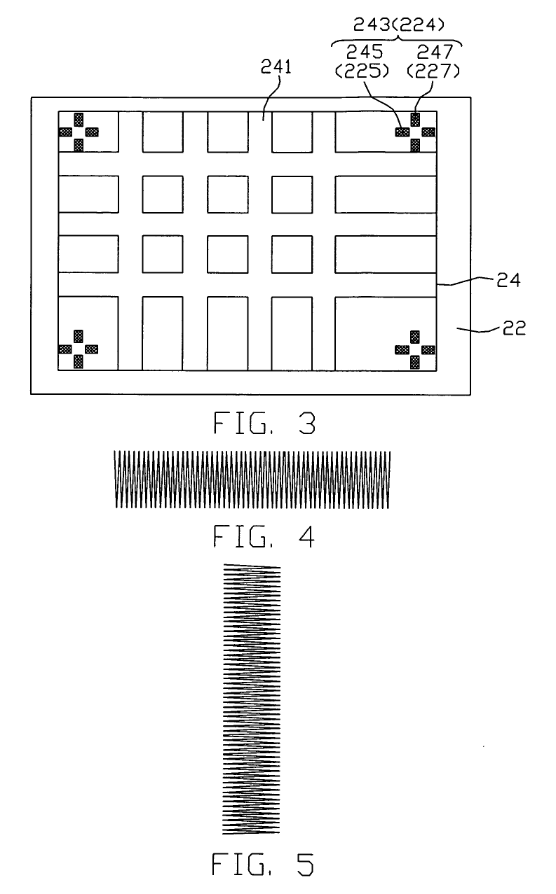

In assembly (as shown in FIG. 3), when the first and the second substrates 22, 24 assembled together, the black matrix 241 covers the plurality of gate lines 221, the plurality of data lines 223 and the plurality of TFTs 226. In the assembly process, first aligning the first and the second positional marks 224, 243 on the first and the second substrates 22, 24. The lines of each first horizontal positional sub-marks 225 and the lines of each second horizontal positional sub-marks 245 cross each other to form a moir\acute{e} fringes aligning pattern as shown in FIG. 4, because the lines of each first horizontal positional marks 225 and the lines of each second horizontal positional marks 245 have different extending directions. The lines of each first vertical positional sub-marks 227 and the lines of each second vertical positional sub-marks 247 cross each other at an angle θ (as shown in FIG. 6) to form a moir\acute{e} fringes pattern as shown in FIG. 4, because the lines of each first vertical positional marks 227 and the lines of each second vertical positional marks 247 have different extending directions. The multiplying effect of the moir\acute{e} fringes is shown in FIG. 6. In as much as the mathematical aspects of the effect of moir\acute{e} fringes in general are well known in the art, they will not be discussed in detail therein. The essential point in accordance with the embodiment is that after the alignment assembly is completed, the resultant moir\acute{e} fringe pattern can be observed and measured on the first or the second substrate 22, 24 by any suitable well known means such as an electron or optical microscope.

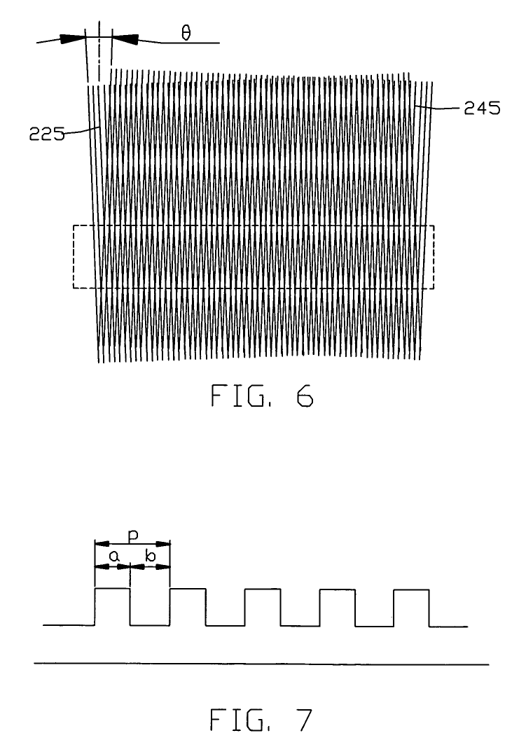

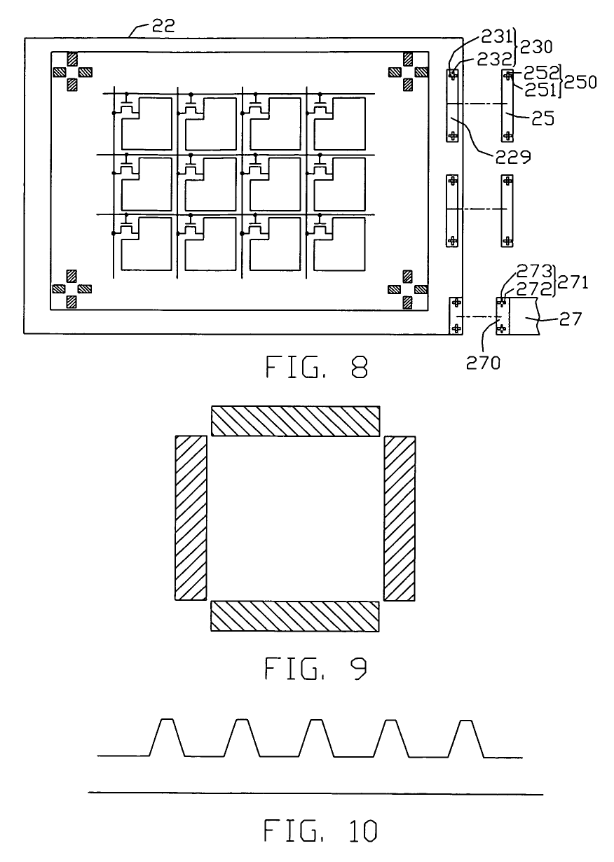

In a preferred embodiment, 2. a periodicity of the lines on the first and the second substrates is in a range of 0.3 um to 1.5 um, a proportion p of a width a of the lines to a pitch b between two adjacent lines is in a range of 1/3 to 3/1 (as shown in FIG. 7), and an intersection angle θ between the lines of the first and the second positional marks is in a range of 0.001 radian to 0.1 radian (as shown in FIG. 6).

Comparing to typical positional mark at the liquid crystal panel, the liquid crystal panel having the first and the second positional marks 224, 243 can effectively improve the aligning precision by utilization of the multiplying effect of the moire fringes. The first and the second positional marks 224, 243 have a plurality of periodically distributed lines thereon, and periodically distributed lines extending along different directions. When the first and the second substrates 22, 24 are assembled, the aligning first and the second positional marks 224, 243 produce a moire fringe aligning pattern, which can show a distinct change when the intersection angle between periodically distributed lines of the first and the second positional marks 224, 243 has a smaller change.

Referring to FIG. 7, the third substrate further has a plurality of bonding portions 229 thereon. Each bonding portions 229 has two third positional marks 230 disposed at two ends thereof. Each third positional mark 230 has two third horizontal sub-marks 231 and two third vertical sub-marks 232, which the two third horizontal sub-marks 231 are arranged along a horizontal line and the two third vertical sub-marks 232 are arranged along a vertical line. The horizontal line and the vertical line cross with each other to define a cross-shaped positional mark. Each third horizontal sub-marks 231 and each third vertical sub-marks 232 has a plurality of parallel lines distributed in a predetermined periods, which the lines are opaque. The distribution period of the third horizontal sub-marks 225 is same to that of the third vertical sub-marks 232. In addition, other regions, no lines covered, of each third horizontal sub-marks 231 and each third vertical sub-marks 232 is transparent.

The liquid crystal panel further has a plurality of chips 25 and a flexible printed board (FPC) 27. The plurality of chips 25 is gate driving circuit or data driving circuit. The FPC 27 has a plurality of bonding region 270. The plurality of chips 25 and the plurality of bonding regions 270 correspond to the bonding portion 229 on the first substrate 22. Each chip 25 has two fourth positional marks 250 disposed at two ends of each chip 25, which respectively correspond to the two positional marks 230 of the bonding portion 229 on the first substrate 22.

Each fourth positional mark 250 has two fourth horizontal sub-marks 251 and two fourth vertical sub-marks 252, which the two fourth horizontal sub-marks 251 are arranged along a horizontal line and the two fourth vertical sub-marks 252 are arranged along a vertical line. The horizontal line and the vertical line cross with each other to define a cross-shaped positional mark. Each fourth horizontal sub-marks 251 and each fourth vertical sub-marks 252 has a plurality of parallel lines distributed in a predetermined periods. The distribution period of the fourth horizontal sub-marks 225 is same to that of the fourth vertical sub-marks 252. In addition, the lines thereof has a dark color than other regions, no lines covered, of each fourth horizontal sub-marks 251 and each fourth vertical sub-marks 252 is transparent.

Each bonding region 270 of the FPC 27 has two fifth positional marks 271. Each fifth positional mark 271 has two fifth horizontal sub-marks 272 and two fifth vertical sub-marks 273, which the two fifth horizontal sub-marks 272 are arranged along a horizontal line and the two fifth vertical sub-marks 273 are arranged along a vertical line. The horizontal line and the vertical line cross with each other to define a cross-shaped positional mark. Each fifth horizontal sub-marks 272 and each fifth vertical sub-marks 273 has a plurality of parallel lines distributed in a predetermined periods. The distribution period of the fifth horizontal sub-marks 225 is same to that of the fifth vertical sub-marks 273. In addition, the lines thereof has a dark color than other regions, no lines covered, of each fifth horizontal sub-marks 272 and each fifth vertical sub-marks 273 is transparent.

In assembly, when the chips 25, the FPC 27 respectively bond at the bonding portions 229 of the first substrate 22, the fourth and the fifth positional marks 250, 271 on the chips 25 and the FPC 27 respectively correspond to the third positional marks 230 on the bonding portions 229.

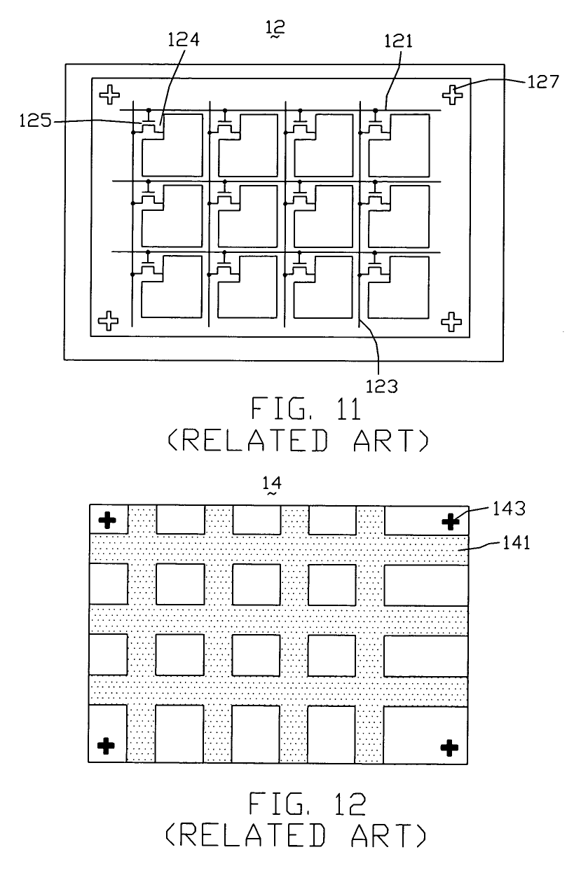

In alternate embodiments of the present invention, when the first and the second substrate in assembled, the two first horizontal positional and the two first vertical positional sub-marks can connected end-to-end, surrounding a rectangular shape, the two second horizontal positional and the two second vertical positional sub-marks can connected end-to-end, surrounding a rectangular shape. The cross-shape of each line can be rectangular (as shown in FIG. 7) or trapezoid (as shown in FIG. 10).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display (LCD) comprising:
a first substrate, which has a first positional mark having a first horizontal positional sub-mark and a first vertical positional sub-mark, perpendicular to each other;
a second substrate, which has a second positional mark having a second horizontal positional sub-mark and a second vertical positional sub-mark, perpendicular to each other;
wherein the first and the second horizontal positional marks correspond to each other, which each have a plurality of periodically distributed parallel lines; the first and the second vertical positional marks correspond to each other, which each have a plurality of vertical distributed parallel lines; when the first and the second substrate are assembled, the lines of the first and the second horizontal positional marks cross each other to form morie fringes, and the lines of first and the second vertical positional marks cross each other to form morie fringes too.

2. The liquid crystal display as claimed in claim 1, wherein the periodicity of the lines on the first and the second substrates is in a range of 0.3 um to 1.5 um.

3. The liquid crystal display as claimed in claim 1, wherein a proportion of a width of the lines to a pitch between two adjacent lines is in a range of 1/3 to 3/1.

4. The liquid crystal display as claimed in claim 1, wherein an intersection angle between the lines of the first and the second positional marks is in a range of 0.001 radian to 0.1 radian.

5. The liquid crystal display as claimed in claim 1, wherein the first positional mark further has a first horizontal positional sub-mark and a first vertical positional sub-mark, perpendicular to each other, the second positional mark further has a second horizontal positional sub-mark and a second vertical positional sub-mark, perpendicular to each other.

6. The liquid crystal display as claimed in claim 5, wherein the two first horizontal positional and the two first vertical positional sub-marks cross to each other to form a crossed shape, the two second horizontal positional and the two second vertical positional sub-marks cross to each other to form a crossed shape.

7. The liquid crystal display as claimed in claim 5, wherein the two first horizontal positional and the two first vertical positional sub-marks can connected end-to-end, surrounding a rectangular shape, the two second horizontal positional and the two second vertical positional sub-marks can connected end-to-end, surrounding a rectangular shape.

8. The liquid crystal display as claimed in claim 1, wherein the first positional marks are disposed at four corners of the first substrate and the second positional marks are disposed at four corners of the second substrate.

9. The liquid crystal display as claimed in claim 1, wherein the distribution periodicity of the lines of the first positional marks is same to that of the lines of the second positional marks.

10. The liquid crystal display as claimed in claim 1, wherein the lines have a lower light transmittance ratio than that of the other region uncovered by the lines of the positional marks.

11. The liquid crystal display as claimed in claim 1, wherein the first substrate further comprises a plurality bonding portions thereon for bonding a plurality of chips or an FPC thereon.

12. The liquid crystal display as claimed in claim 10, wherein each boning portions has a third positional mark having a third horizontal positional sub-mark and a third vertical positional sub-mark, perpendicular to each other.

13. The liquid crystal display as claimed in claim 10, wherein each chip has a fourth positional mark having a fourth horizontal positional sub-mark and a fourth vertical positional sub-mark, perpendicular to each other.

14. The liquid crystal display as claimed in claim 10, wherein each boning portions has a fifth positional mark having a fifth horizontal positional sub-mark and a fifth vertical positional sub-mark, perpendicular to each other.

15. The liquid crystal display as claimed in claim 1, wherein the cross-shape of each lines can be rectangular or trapezoid.

16. A liquid crystal display (LCD) comprising:
a first substrate, which has a first positional mark having a first horizontal positional sub-mark and a first vertical positional sub-mark, perpendicular to each other;
a second substrate, which has a second positional mark having a second horizontal positional sub-mark and a second vertical positional sub-mark, perpendicular to each other;
the first and the second horizontal positional marks corresponding to each other, and the first and the second vertical positional marks corresponding to each other; wherein
at least either each of the first and second horizontal positional marks has a plurality of periodically distributed parallel lines or each of the first and second vertical positional marks has a plurality of periodically distributed parallel lines, so that when the first and the second substrate are assembled, at least either the lines of the first and the second horizontal positional marks cross each other to form morie fringes, or the lines of first and the second vertical positional marks cross each other to form morie fringes too.

17. The liquid crystal display as claimed in claim 16, wherein both the first and second horizontal positional marks and the first and second vertical positional marks have a plurality of periodically distributed parallel lines.

18. A liquid crystal display (LCD) comprising:
a first substrate, which has a first positional mark having a first direction one positional sub-mark along a first direction and a first direction two positional sub-mark along a second direction angled to the first direction;
a second substrate, which has a second direction one positional mark having a second positional sub-mark along a first direction and a second direction two positional sub-mark along the second direction angled to each other;
the first and the second direction one positional marks corresponding to each other, and the first and the second direction two positional marks corresponding to each other; wherein
at least either each of the first and second direction one positional marks has a plurality of periodically distributed parallel lines or each of the first and second direction two positional marks has a plurality of periodically distributed parallel lines, so that when the first and the second substrate are assembled, at least either the lines of the first and the second direction one positional marks cross each other to form morie fringes, or the lines of first and the second direction two positional marks cross each other to form morie fringes too.

19. The liquid crystal display as claimed in claim 18, wherein the first direction is perpendicular to the second direction.

20. The liquid crystal display as claimed in claim 18, wherein both the first and second direction one positional marks and the first and second direction two positional marks have a plurality of periodically distributed parallel lines.
